(19) United States
(12) Patent Application Publication
(10) Pub. No.: US 2008/0151233 A1
(43) Pub. Date: Jun. 26, 2008

(54) Method And Apparatus For Classification Of Surfaces

(75) Inventors: Mogens Blanke, Farum (DK); Ian David Braithwaite, Copenhagen N. (DK)

Correspondence Address: KNOBBE MARTENS OLSON & BEAR LLP, 2040 MAIN STREET, FOURTEENTH FLOOR, IRVINE, CA, 92614, US

(73) Assignee: DANMARKS TEKNISKE UNIVERSITET, Lyngby (DK)

(21) Appl. No.: 11/722,987

(22) PCT Filed: Dec. 29, 2005
(86) PCT No.: PCT/DK2005/000837

§ 371 Date: Feb. 6, 2008

Related U.S. Application Data
(60) Provisional application No. 60/640,057, filed on Dec. 30, 2004.

(30) Foreign Application Priority Data
Dec. 30, 2004 (EP) 04031021.1

(51) Int. Cl. G01N 21/94

(52) U.S. Cl. 356/237.2; 901/47

(57) ABSTRACT

A method for optically determining whether a region of a surface is clean or contaminated. The method finds applicability in connection with cleaning robots, for example in pig house cleaning. It comprises the steps of—selecting a first and a second, different narrow band of wavelengths for illuminating the region, —selecting a first class with two-dimensional values (XI, Y I) which corresponds to a clean region and a second class with two-dimensional values (X2, Y2) which corresponds to a contaminated region, where X1 and X2 are values for the reflectance from the region at the first band, and Y1 and Y2 are values for the reflectance from the region at the second band, —illuminating the region with light having the first narrow band of wavelengths and illuminating the region with light having the second narrow band of wavelengths, —measuring the reflected light from the region at the first and the second band to determine the respective reflectance values RI and R2, —assigning the two-dimensional value (R1, R2) to the first class, if there exist a value (X1, Y1)=(R1, R2) and assign the two-dimensional value (RI, R2) to the second class, if there exist a value (X2, Y2)=(R I, R2).

### FIELD OF THE INVENTION

The invention relates to optical methods for determining whether a surface is clean or dirty, preferably in connection with an automated robot cleaning process.

### BACKGROUND OF THE INVENTION

Manual cleaning of livestock buildings, using high pressure cleaning technology, is a tedious and health threatening task conducted by human labour in intensive livestock production. To remove this health hazard, recent development has resulted in cleaning robots, some of which have been commercialised. The working principle of these robots is to follow a pattern initially taught to them by the operator. Experience shows that cleaning effectiveness is poor and utilisation of detergent and water is higher than for manual cleaning. Furthermore, robot cleaning entails subsequent manual cleaning as robots in many cases are unable to detect the cleanliness of surfaces.

An inspection system for the control of surfaces of teats before milking of cows has been described by Bull et al. in “Optical teat inspection for automatic milking system” published in Computers and Electronics in Agriculture 12 (1995) 121-130. It was found that the ratio of reflectance at a wavelength in the chlorophyll absorption band and a closely adjacent reference wavelength gave an indication of whether the teat was clean or not. This is due to the fact that manure, which is the typical dirt on teats, contains chlorophyll. However, as pointed out in this article, this method has a number of general shortcomings, as it is not a useful test of cleanliness of black teats. Furthermore, the method relies on the fact that chlorophyll is part of the contamination. However, in the case of contamination in pighouses, this is not the case, as pigs are not fed with chlorophyll containing food.

### DESCRIPTION/SUMMARY OF THE INVENTION

It is the purpose of the invention to provide an optical method for the clear distinction between a dirty and a clean surface.

This purpose is achieved by a method according to the invention for optically determining, whether a region of a surface is clean or contaminated. The invention comprises the steps of
selecting a first and a second, different narrow band of wavelengths for illuminating the region,
selecting a first class with two-dimensional values [X1, Y1] that corresponds to a definition as clean for the region and a disjunct second class with two-dimensional values [X2, Y2] that corresponds to a definition as contaminated for the region, where X1 and X2 are values for the reflectance from the region at the first band, and Y1 and Y2 are values for the reflectance from the region at the second band,
illuminating the region with light having the first narrow band of wavelengths and illuminating the region with light having the second narrow band of wavelengths,
measuring the reflected light from the region at the first and the second band to determine the respective reflectance values R1 and R2,
assigning the two-dimensional value [R1, R2] to the first class, if there exist a value [X1, Y1] that is equal to [R1, R2] and assign the two-dimensional value [R1, R2] to the second class, if there exist a value [X2, Y2] that is equal to [R1, R2].

The method according to the invention may comprise a number of steps as described in more detail in the following. A first and a second, different narrow band of wavelengths for illuminating the region are selected, for example bands in the infrared and in the visible light wavelength region. This selection is made such that a good differentiation can be found between a contaminated and a clean surface. How this is done in practice is explained below. A first class with two-dimensional values [X1, Y1] is selected for defining a clean state, where X1 is a value for reflectance from the region as it is expected if the region is in a clean state and when illuminated at the first band, whereas Y1 is a value for reflectance if the region is in a clean state and when illuminated at the second band. Correspondingly a, disjunct, second class with two-dimensional values [X2, Y2] is selected for defining a contaminated state, where X2 and Y2 are values for the reflectance as they are expected if the region is in a contaminated state and when illuminated at the first and second band, respectively. In practice, the region may be successively illuminated with light having the first narrow band of wavelengths, for example red light or near infrared light, and with light having the second narrow band of wavelengths, for example blue light, and the reflected light is measured from the region at the first and the second band. By measuring the actually reflected light, the respective reflectance values R1 and R2 in the first and the second wavelength band are determined. From the actually measured reflectance R1, and R2, a two-dimensional value [R1, R2] can be assigned to the first class, if there exist a value [X1, Y1] that is equal to [R1, R2] and to the second class, if there exist a value [X2, Y2] that is equal to [R1, R2].

By the method according to the invention, it is possible to make a clear distinction between a clean and a contaminated region on a surface. As the reflectance from the region may vary, for example due to inhomogeneous distribution of contamination in the region, using only one wavelength leads to a rather unsafe determination of, whether the region is clean or not. However, by selecting and using another wavelength in combination, the uncertainty can be reduced to a very low level. It should also be noted that the method and apparatus according to the invention work polariser-free, thus, it is not necessary to use any kind of polarising equipment in order to use the invention.

How the term narrow for the wavelength band is used in contrast to white light, and how it has to be understood depends on the application. The wavelength band should be much narrower than the wavelength distance between the bands. When using diodes for illumination, typical bandwidths are some tens of nm, which has proven to be feasible. If the band is relatively broad, the resolution may not be sufficient if not additional filtering is used.

It should be stressed, that the term light covers not only visible light but should be understood widely, for example also covering infrared and ultraviolet light.

The illumination and measuring in a method according to the invention may be performed by different combinations of illumination mode and measuring mode. Important is that the illumination of the region is performed with light containing at least the first narrow band of wavelengths and the second narrow band of wavelengths.

In a first embodiment, this is achieved by illuminating the region with light sources emitting light only containing wavelengths within these two wavelengths bands. In a practical embodiment, light diodes are used which only emit light in these narrow wavelength bands. Alternatively, light sources containing also other wavelengths can be used followed by some kind of wavelength filter for selectively transmitting only the two narrow bands for the illumination of the region.

In an alternative embodiment, the light sources emitting light for illumination of the region may contain additional wavelengths outside the first and the second narrow band. In this case, the reflected light after illumination of the region is filtered, for example before the reflected light enters a detector, with an wavelength filter having a selection of wavelengths only in the first narrow band of wavelengths and the second narrow band of wavelengths. This wavelength filtering can be performed, for example, with an optical filter or a grating with a selective transmission only in the first narrow band of wavelengths and the second narrow band of wavelengths or with a wavelength selection in the detector itself.

Light with wavelengths outside the first and second narrow band may be of different nature depending on the kind of illumination. For example, it may be broadband light which has a bandwidth covering both the first and the second narrow band. This could be white light or one broad but limited band of wavelengths, for example a part of the visible light, possibly extending into the infrared region. For example, such light can be obtained from standard lamps, photographic flash or sunlight. However, in this connection, it should be noted that photographic flash typically does not extend into the infrared regime with substantial light power, which is a disadvantage, if infrared light is desired for the analysis. Sunlight in contrast does contain ultraviolet light which may cause a frequency shift, especially if the contamination contains chlorophyll, which may be disadvantageous, as this may lead to uncertainties in the measurements due to a change of the light spectrum between the light for illumination and the light reflected/emitted from the illumination region.

Alternatively, the light for illumination may comprise different bands, where one relatively broad band covers the first narrow band and another relatively broad band covers the second narrow band. The latter may also contain additional bands. A further alternative is illumination with a number of more than two narrow bands of wavelengths, where one narrow band is identical to the above mentioned first narrow band of wavelengths and another band is identical to the above mentioned second narrow band of wavelength.

Illumination by polychromatic light and wavelength selection, for example by a band-pass filter, has the advantage that it can be achieved at low cost. Nevertheless, this is not a preferred solution when it comes to signal to noise ratio. The reason for an inferior signal to noise ratio is that the aim for illumination with a certain power in the first and second narrow wavelength bands requires a general high power in the light source. Most of the light and the corresponding power then lies outside the first and the second narrow wavelength bands. As certain materials have a tendency for luminescence, illumination at certain wavelengths outside the first and the second wavelength band may cause emission at other wavelengths, for example in the first and the second wavelength band, hence disturbing the classification.

In the case, where light emitters are used to illuminate the region, the light emitters only having a first and the second narrow wavelength bands, it may still be an advantage to use a bandwidth filter in front of or in the detector that measures the reflected light. One reason is that in practice, for example when measuring in pig houses, often daylight is also illuminating the region. In order for the final signal to be as clean as possible, the reflected part of the daylight should be filtered out outside the first and the second narrow bands.

In a certain practical embodiment, the invention may include image acquisition with an optoelectronic system of the surface that contains the possibly contaminated region and subsequent image processing. The image of the surface may then be acquired in sections by moving the optoelectronic system with respect to the surface. For example, by using a CCD camera or a video camera, the image section is divided into a multiplicity of pixels forming an image matrix and each pixel is assigned a signal value representative for the reflected light from the corresponding region. This signal value is then evaluated in order to find the quantitative values for the reflection. The size of a region can be chosen in accordance with the desired optical resolution for the contamination on the surface. For example, the region may be chosen to have a segment area of 2 mm×2 mm. Though the invention is preferably used in connection with a video camera or CCD camera, it is within the scope of the invention to use light detectors that only investigate one region at a time.

For defining the classes, a probability density X as a function for the reflectance from the region at the first band and a probability density Y as a function for the reflectance from the region at the second band may be determined. In a two-dimensional representation with the reflectance values of X as ordinate and Y as coordinate, the classes may be found by selecting a border between two groups of entrances, where one group is representative for a clean region and the other group is representative for a contaminated region.

The degree of reduction of the uncertainty depends in many cases on the selection of the two-dimensional values for the first and the second class. According to the invention, the selection of the first and the second band of wavelengths may involve calculation of the Jeffreys-Matusita distance for reflectance probabilities for a range of first wavelength bands and a range of second wavelength bands. With this at hand, a combination of the first and the second wavelength band may be selected for which the JM distance is above a predetermined value, for example above 0.8, above 1.0 or above 1.2. The maximum value of the Jeffreys-Matusita distance is the square root of 2.

Alternatively, one may calculate an upper bound for a misclassification error for reflectance probabilities for a range of first wavelength bands and a range of second wavelength bands and select a combination of the first and the second wavelength bands for which the upper bound of the misclassification error is below a predetermined value. Such a predetermined value may be 10%, 5% or even as low as 2%. The lower the value, the lower is the potential for misclassification. When using the Jeffreys-Matusita distance JM, such an upper bound can be defined as 1½ JM².

The selected wavelength may be found according to the surface to be investigated. For example, the first band may be around 800 nm and the second band around 650 nm in order to determine the cleanliness of concrete. Alternatively, the first band may be around 650 nm and the second band around 450 nm in order to determine the cleanliness of steel. These wavelengths are only advantageous examples and not limiting the invention, as other wavelength bands may be used with a satisfactory result.

Applications to classification between clean and dirty generally require selection of appropriate combination of wavelengths according to the spectral properties of the specific materials and the composition of contamination we would characterize as dirt. The selection of appropriate wavelengths is best done using the method described in connection with this invention but alternative methods exist for wavelength selection, including well known methods of factor analysis. Methods from factor analysis that are based on general distributions (not necessarily normal) were tested but these tests do not provide the guaranteed limits for misclassification available with our preferred method. For a discussion, see Blanke, M: A Note on Variance and Factor Analysis of ISAC Spectral Reflectance Data. ISAC Research Report, Section of Automation at Ørsted•DTU, Technical University of Denmark, Build. 326, DK 2800 Kgs. Lyngby, Denmark, July 2005. 46 pp.

Different surfaces typically influence the result of the measurements. Thus it is advantageous, if the selection of the first and the second band is dependent on the surface material in the region. For some surfaces, for example if a number of different materials such as steel, polymer and concrete are involved, differentiation may be difficult even with two wavelengths. In this case, the method of the invention can be used to extend with one or more further wavelength bands in an analogous way. According to the invention, the method may comprise selecting a third narrow wavelength band in addition, selecting a first class with three-dimensional values [X1, Y1, Z1] which corresponds to a clean region and a second class with three-dimensional values [X2, Y2, Z2] which corresponds to a contaminated region, where Z1 and Z2 are values for the reflectance from the region at the third band. The region is illuminated in addition with light having the third band, and the reflected light from the region at the third band is measured to determine the respective reflectance R3. Analogous to the description above, a three-dimensional value [R1, R2, R3] is assigned to the first class, if there exist a value [X1, Y1, Z1] that equals [R1, R2, R3], and the three dimensional value [R1, R2, R3] is assigned to the second class, if there exist a value [X2, Y2, Z2] that equals [R1, R2, R3].

In a practical embodiment for the method above, an apparatus may be used comprising an illuminator for illumination with the first wavelength and the second wavelength and a digital video camera electronically coupled to a computer for measuring the reflected light with a spatial resolution. The camera may advantageously be arranged to detect the reflected light under conditions minimising the direct reflection from the surface of the region. For example, the camera may receive the light reflected in a direction normal to the surface, whereas the illumination is in an angle of 45 degrees with the surface.

Such a method and apparatus may be used for a cleaning robot for performing the method described. In a specific embodiment, the cleaning robot comprises a vehicle onto which at least one robot arm is mounted, and wherein an illuminator for illuminating the region with light having the first narrow band of wavelengths and illuminating the region with light having the second narrow band of wavelengths is mounted on a robot arm and wherein a camera for measuring the reflected light from the region at the first and the second band is mounted on a robot arm. For example, the invention may include the use of a commercially available robot, for example one from the company Alto, which has been modified in connection with the invention as described below.

The method according to the invention may be used for assessing the success of cleaning procedures on contaminated surfaces by using an optoelectronic system for image acquisition, image processing and image representation. The aim is to achieve an assessment which is current and quantitative. This is ensured in terms of process engineering owing to the fact that the image of the surface to be assessed is acquired in sections, that the image section is divided into a multiplicity of pixels forming an image matrix of pixels, where each pixel represents a region that is to be examined. The method has initially been developed for automatic cleaning of animal houses, especially pig houses, but the invention is of general nature and may be used in connection with other applications as well, for example cleaning of slaughterhouses or other industrial environments in general.

The invention could be applicable in a variety of cleaning applications, including but not limited to machine assisted washing of floors in large public areas, institutions, airports, storage areas, containers, inspection of ship tanks from remains of cargo, oil, remains of fish.

The sensor is envisaged used for both quality control of surface cleanness and in connection with automated cleaning where sensor information is used to guide a cleaning apparatus to do specific cleaning efforts at the areas characterized as having remains of dirt.

### SHORT DESCRIPTION OF THE DRAWINGS

The invention will be explained in more detail with reference to the drawings, where

FIG. 1 is a sketch of a set-up for measuring reflection from a surface region,

FIG. 2 shows Prior Art results on the reflectance of the different materials as measured with a spectrometer,

FIG. 3 shows the Prior Art results for clean and for contaminated samples with mean and ±1 and ±2 standard deviations,

FIG. 4 shows probability density distributions obtained at two different wavelengths for clean and dirty regions,

FIG. 5 is a two-dimensional combination of the probability densities of FIG. 4,

FIG. 6 is a spectrum illustrating JM distance for a range of wavelength pairs using actual data for concrete,

FIG. 7 is a contour plot for the misclassification bound in the range 0-10%,

FIG. 8 is a spectrum for the classification error upper bound for aged solid concrete floor,

FIG. 9 shows a spectrum for the classification error upper bound for aged slatted concrete floor, FIG. 9a for two wavelengths and FIG. 9b for three wavelengths,

FIG. 10 shows scatter plots, FIG. 10 a for wavelengths 800 nm vs. 650 nm and FIG. 10b for wavelengths 650 nm vs. 450 nm,

FIG. 11 is a flow diagram for the software implementation,

FIG. 12 shows results of the algorithm used on images from a pig pen,

FIG. 13 shown a hardware implementation in a robot,

FIG. 14 is a cleanness map obtained from measurements in a pig pen

FIG. 15 is an image of a wet slatted floor with lumps of dirt and two straight gaps,

FIG. 16 shows a classification map; the horizontal axis shows reflection at 660 nm and the vertical axis shows reflection at 890 nm,

FIG. 17 shows the cleanness map corresponding to the image FIG. 15.

### DETAILED DESCRIPTION/PREFERRED EMBODIMENT

Vision Model

The basic elements in a vision-based measurement system consist of three components: illumination system, subject and camera. The complexity of the system is to a large degree determined by the extent to which the relative placement of the three can be controlled and constrained. Particularly in the case of illumination, control is often critical—external (stray) light can be a seriously limiting factor for system effectiveness.

The light collected by a camera lens is determined by the colour of the viewed object, the spectra of the illuminating light sources and the relative geometries of these to the camera. The influence of geometry on measured colour can be seen clearly with reflective materials: when viewed such that a light source is directly reflected in a surface, the reflected light is almost entirely determined by the light source rather than by the reflecting material. Since this behaviour makes measurement of surface colour impossible, measurement systems attempt to avoid this geometry.

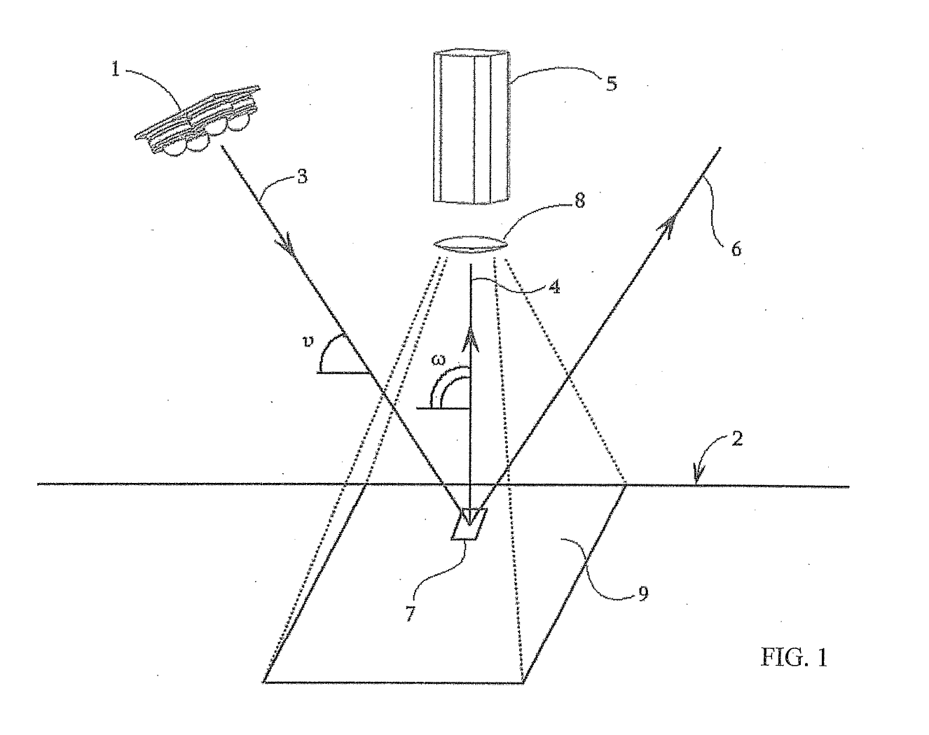

FIG. 1 illustrates a set-up that may be used in connection with the invention. An illuminator 1 illuminates a surface 2 with a light 3 under a certain angle v, for example 45°. A detector, in this case a camera 5, receives reflected light 4 under an angle w, for example 90° in order to avoid directly reflected light 6. The size of the region 7 to be investigated depends on the optical geometry including distances, angles and lenses 8. The image of a surface acquired in sections, where an image section 9 is divided into a multiplicity of pixels forming an image matrix of pixels, where each pixel represents a region 7 that is to be examined. Thus, with a CCD camera connected to a computer, a large number of regions, one region per pixel can be investigated very fast by employing computer techniques. As an illuminator 1, light diodes have been used with success. These have typically light emission within a narrow frequency band. The illuminator 1 is shown with four diodes, each diode having a different wavelength, where the wavelengths are selected in order to achieve a good discrimination between the contaminated and the clean state. In order to avoid shadow effects, illumination may be performed with more than one illuminator, for example with two illuminators located oppositely with respect to the camera.

If direct reflections can be avoided, the light reaching a viewer can be considered to be independent of the measurement system geometry. In this case, the spectrum of the light 4 entering the camera 5 is simply a function of the spectra of the light sources 1 and the colour of the material being viewed on the surface 2. Uniform (homogeneous) materials have single colour, while composite (inhomogeneous) materials may have varying colours across the surface 2. If a single pixel in the camera is focused on an region 7 with area A of material, then the spectrum of the light incident on the pixel is given by

s(λ)=η_{Δ}c(λ,a)i(λ)da

where c is the surface colour as a function of wavelength λ and position, and i is the spectrum of the illuminating light. Surface colour is specified as the amount (fraction) of light reflected by the surface, relative to a standard reference surface. The camera pixel itself has a wavelength dependent sensitivity across some range of wavelengths. For a CCD camera, this sensitivity ranges over wavelengths from just into the ultraviolet up to the near-infrared. Further, pixel characteristics can be modified by the addition of a colour filter, to limit sensitivity to certain wavelengths. The electrical current Iᵢ induced in a single pixel is therefore be given by

Iᵢ∝∫_{Λ}s(λ)fᵢ(λ)η(λ)dλ

where fᵢ is the filter characteristic, giving the fraction of the light transmitted by the filter, and η is the CCD sensitivity.

In addition to choosing the characteristics of a filter, the sensor designer also has some control over the subject illumination. The illumination term i in the equation above-consists of background illumination together with light sources integrated into the sensor system. So i consists of two terms

i(λ)=i_{B}(λ)+iᵢ(λ)

where the first term represents a disturbance and the second term a design parameter. The subscripts i in the equations above indicate that the sensor operates with a number of channels, consisting of light source and filter pairs. Thus, a sensor pixel measurement consists of a vector of readings, one for each channel.

x=(I₁ . . . Iₚ)

Finally, all the image pixels can be assembled into an image array, giving a single camera measurement the form

$$X = [ \begin{matrix}{x}_{11} & … & {x}_{w 1} \\ ⋮ & ⋰ & ⋮ \\ {x}_{1 h} & … & {x}_{wh}\end{matrix} ]$$

where w and h are the width and height of the image in pixels, respectively.

Properties of Clean and Dirty Surfaces

How to catch the cleanness information on the different types of surfaces is the major issue in design of an intelligent sensor. One of the hypotheses is that the reflectance of building materials and contamination differs in the visual or the near infrared wavelength range. To validate the hypotheses, the optical properties of surfaces to be cleaned in a pighouse and the different types of dirt found in finishing pig units were investigated in the VIS-NIR optical range. For validation, an ordinary CCD camera with selected filters or defined light sources can be used for cleanness detection.

Measurements were conducted in a laboratory to gain the necessary knowledge on spectral characteristics of different surface materials inside pig buildings. The selected housing elements of inventory materials were taken from a pig production building after 4-5 weeks in real environment in pig pens. In all, four surface materials were considered: concrete, plastic, wood and metal, in each of four conditions: clean and dry, clean and wet, dry with dirt and wet with dirt. In each measurement condition, spectral data were sampled at 20 randomly determined positions, in order to avoid the effect caused by the non-homogeneous properties of the measured surfaces. At each measurement position, spectral outputs were sampled 5 times with an integration time of 2 seconds for each. The average of the five spectra was recorded for analysis.

The spectrometer used in the characterisation was a diffraction grating spectrometer, incorporating a 2048 element CCD (charge-coupled device) detector. The spectral range 400-1100 nm was covered using a 10 μm slit, giving a spectral resolution of 1.4 nm. The light source used was a Tungsten-Krypton lamp with a colour temperature of 2800K, suitable for the VIS/NIR applications from 350-1700 nm.

A Y-type armored fibre optic reflectance probe, with six illuminating fibres around one read fibre (400 μm) specified for VIS/NIR was used to connect the light source, the spectrometer and the measurement objective aided with a probe holder. The probe head was maintained at 45° to the measured surface and a distance of 7 mm from the surface.

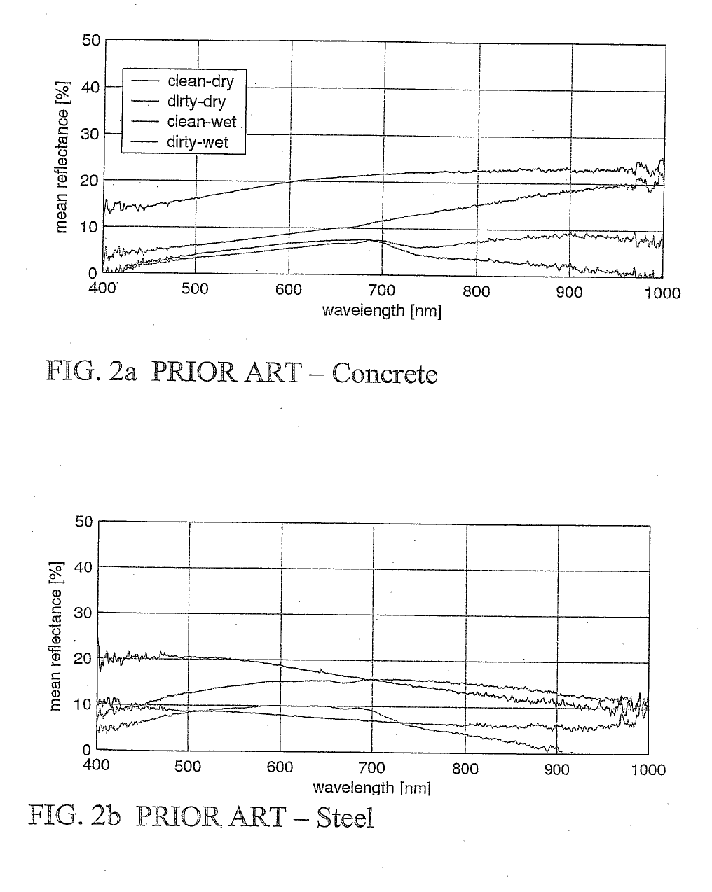

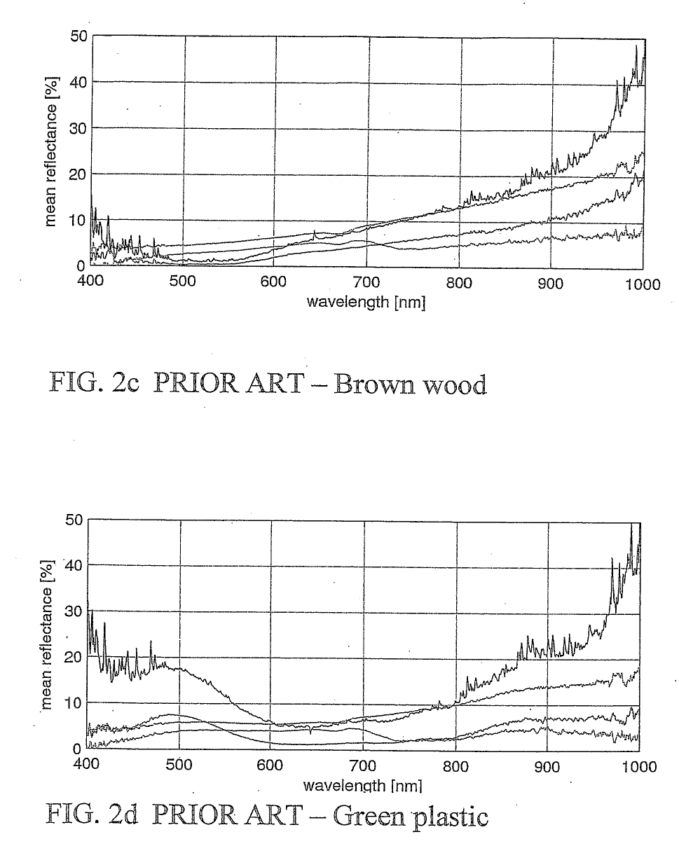

Published by G. Zhang and J. S. Strøm “Spectral signatures of surface materials in pig buildings” in Proc. of International Symposium of the CIGR “New trends in farm buildings”, Evora, Portugal. Proc. CD-fb2004, 316 are primary results on the reflectance of the different materials under the measurement conditions are shown in FIGS. 2(a)-2(d). The curves show the data from the 20 random measurement points under each measurement set-up where the four curves in each spectrum correspond to conditions that are clean-dry, dirty-dry, clean-wet and dirty-wet.

The spectral analysis system has its highest sensitivity in the range 500 to 700 nm, but the entire range from 400 to 1000 nm is useful to provide reflection as function of wavelength. The results suggest that it will be able to make discrimination and hence classify areas that are visually clean. A scenario with multi-spectral analysis, combined with appropriate illumination or camera filters has therefore been pursued.

Concrete, the predominant material used for floors, is an inorganic material. The manure and the contaminants may thus be spotted as organic material on inorganic background. Under wet condition, a significant difference may be seen in wavelengths of 750-1000 nm, FIG. 2a. However, the clear differences for steel (stainless) are shown in 400-500 and 950-1000 nm, FIG. 2b. For the brown wood sheet, the reflectance under dirty-wet conditions was higher in the wavelengths of 500-700 nm and lower in 750-1000 nm compared with clean-wet conditions. For the green plastic sheet, the reflectance under dirty-wet condition was lower for wavelengths lower than 550 nm and higher than 800 nm, but higher in wavelength between 600-700 nm compared with clean-wet condition.

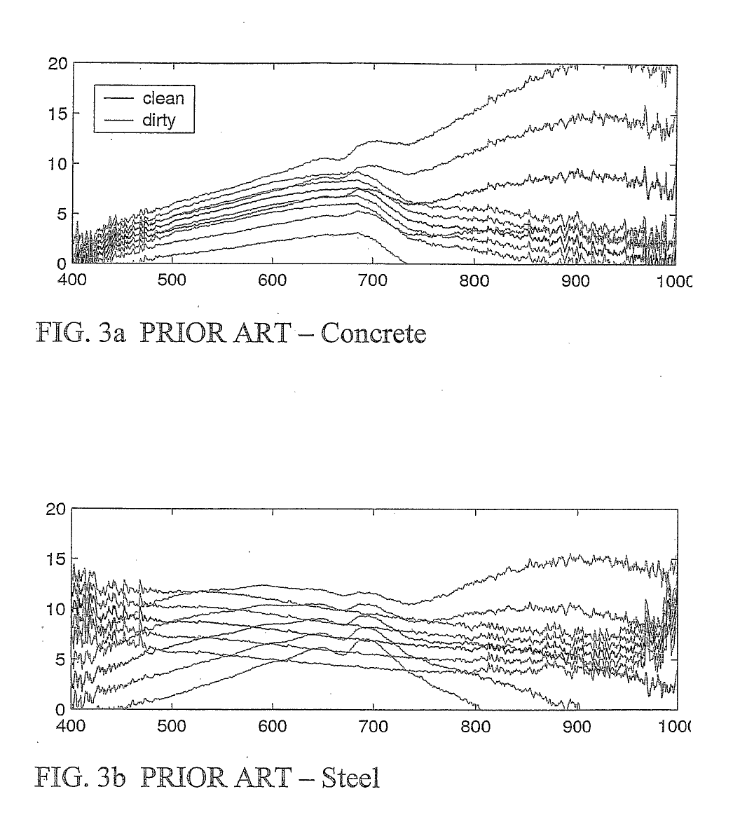

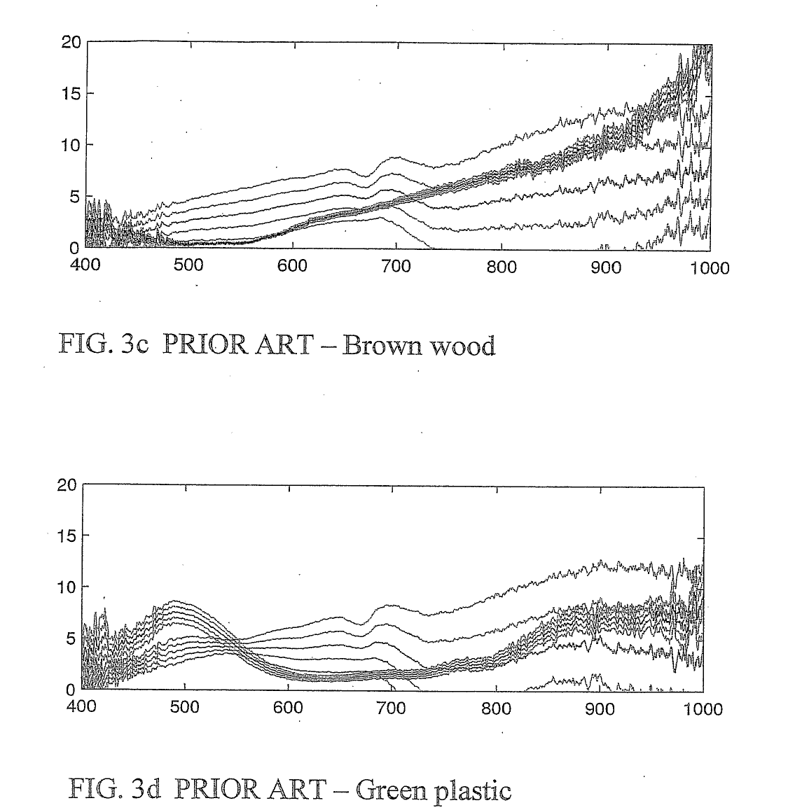

The measurements of the reflection vary statistically, which is illustrated in FIG. 3a-3d where the measurements for clean-dry and dirty-dry are shown with their mean value and ±1 and ±2 standard deviations. These measurements are published by G. Zhang and J. S. Strøm “Spectral signatures of surface materials in pig buildings” in Proc. of International Symposium of the CIGR “New trends in farm buildings”, Evora, Portugal. Proc. CD-fb2004, 316.

Classification

Classifying an object is the process of taking measurements of some of the objects properties, and based on these measurements assigning it to one of a number of classes. In pixel-based visual classification, each class represents a colour, or range of colours. For a standard colour video camera, each pixel measurement contains three intensities: one each for red, blue and green.

Choosing the “most likely” class for a pixel using Bayesian classification uses the statistical properties of each class to compute the likelihood of a measurement belonging to each class. The classification is then that class with the greatest (post priori) likelihood. The statistical properties of classes are normally not known exactly in advance. These are therefore estimated based on measurements of previously classified objects.

Classification of a surface part as clean or not clean has obvious consequences in the application, for example where the invention is used in connection with automated cleaning of industrial environments or in farming environments such as pig houses. For the clean surface, misclassification as not clean will call for another round of cleaning by the robot. Misclassification of the unclean surface as clean has consequences for the quality of the cleaning result. Subsequent manual inspection and cleaning should be avoided if possible, but it could be acceptable for a user to have certain areas characterised as uncertain, as long as these do not constitute a large part of the total area to clean.

With a clear relation between cost and the probability of misclassification, methods to extract features of the observed spectra would be preferred, that could minimise the probability of misclassification, constrained by the complexity of the vision system.

In our context, the number of frequency bands to be analysed has an impact on both cost of computer-vision equipment and time needed to capture and analyse the pictures taken. Several classical methods exist that provide measures of misclassification and separability between the clean and unclean cases.

Let a frequency band in the spectrum be chosen for analysis. A set of measurements on a surface will have a distribution of reflectivity due to differences in the clean surface itself and due to the uneven distribution of residues to be cleaned. Let the distribution function for an ensemble of measurements given the case is θᵢ (clean or not clean):

f(r|θᵢ)=fᵢ(r)

A convenient first assumption for analytical discussion is that the population has a multivariate normal distribution of dimension n,

$${f}_{i} ( r ) = N ( {μ}_{i} , {\sum }_{i} ) = \frac{1}{{\sqrt{2 π} }^{n} \sqrt{det {\sum }_{i}}} exp ( - \frac{1}{2} {( r - {μ}_{i} )}^{T} {\sum }_{i}^{- 1} ( r - {μ}_{i} ) )$$

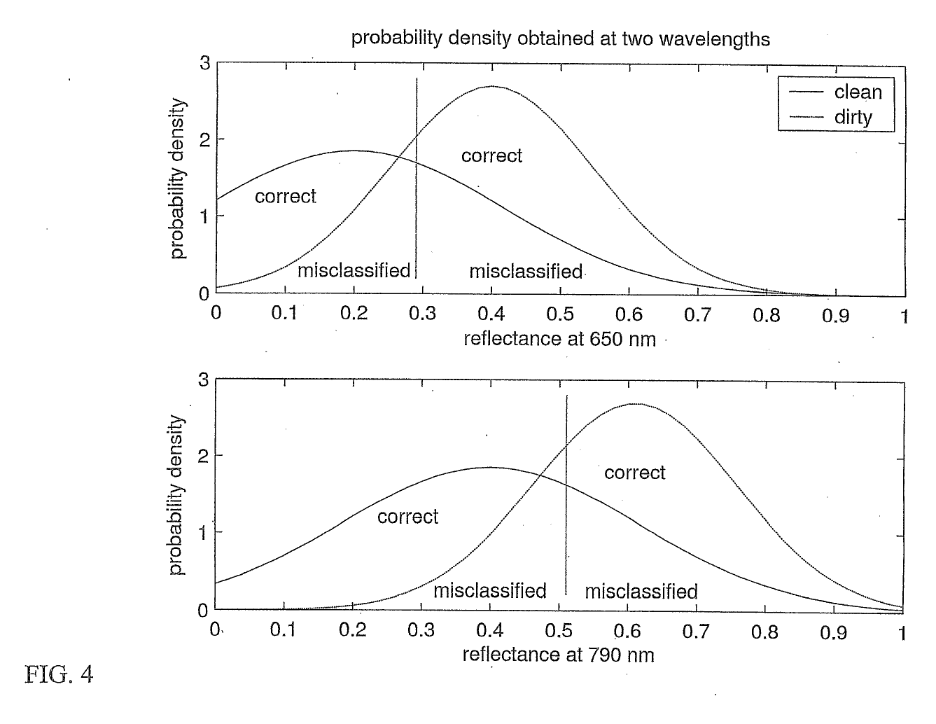

With two such distributions for the clean and unclean cases, respectively, the problem is to determine, from one or more measurements of reflectance, whether a given measurement represents a clean or an unclean area. This is illustrated in FIG. 4 showing the probability density distributions for reflectance of clean and dirty regions at a narrow wavelength band around 650 nm in the upper spectrum and at a narrow wavelength band at 790 nm in the lower spectrum. For each spectrum, a measurement would be characterised as representing a clean area when reflectance is below the vertical, dashed borderline between the two distributions. FIG. 4 also shows the probability for misclassification. In signal processing, measurement noise is often the prime source of misclassification and repeated measurements would be used to increase the likelihood that the right decision is made.

When noise is the prime nuisance, optimisation based on the Kullbak divergence may be used, e.g. in a symmetric version of the divergence,

$${D}_{ij} = E \{ ln \frac{{f}_{i} ( r )}{{f}_{j} ( r )} \vert {θ}_{i} \} + E \{ ln \frac{{f}_{i} ( r )}{{f}_{j} ( r )} \vert {θ}_{j} \}$$

as explained in T. Kailath: “The divergence and Bhattacharyya distance measures in signal selection.” IEEE Transaction on Communication Technology, com-15(1):52-60, February 1967.

According to the invention, however, the primary source of uncertainty is the fact that reflectance of the background material and of the contamination will vary as a function of where we measure, i.e. it is a function of location and not of time. Therefore, it is necessary to find a technique by which the probability of misclassification Pₑ is minimised using a single measurement only.

If the divergence measure is used it is possible to give a lower bound and an upper bound, see for T. Kailath: “The divergence and Bhattacharyya distance measures in signal selection” IEEE Transaction on Communication Technology, com-15(1):52-60, February 1967 or J. Lin: “Divergence measures based on the Shannon entropy” IEEE Transaction son Information Theory, 37(1):145-151, January 1991.

With reference to the article by Kameo Matusita: “A distance and related statistics in multivariate analysis”, published in P. R. Krishnaiah, editor, Multivariate Analysis, pages 187-200. Academic, Press, New York, 1966, the Jeffreys-Matusita distance (JM distance) between distributions fᵢ and fⱼ, is [6]

$${J}_{ij} = {( {\int }_{Ω} {( \sqrt{{f}_{i} ( r )} - \sqrt{{f}_{j} ( r )} )}^{2} d r )}^{\frac{1}{2}}$$

A salient feature of the JM distance is its applicability to arbitrary distributions. The JM distance is Jᵢⱼ=0 when the distributions fᵢ(r) and fⱼ(r) are equal. The JM distance takes the value Jᵢⱼ=√2 when the two distributions are totally separated.

Bhattachatyya introduced the coefficient

pᵢⱼ=∫_{Ω}\sqrt{fᵢ(r)}\sqrt{fⱼ(r)}dr

and used the negative logarithm, aᵢⱼ, of this quantity,

αᵢⱼ=−lnpᵢⱼ.

These have the obvious relation to the JM distance

Jᵢⱼ²=2(1−pᵢⱼ)=2(1−e^{-α}^{ᵢⱼ})

In T. Kailath: “The divergence and Bhattacharyya distance measures in signal selection” IEEE Transaction on Communication Technology, com-15(1):52-60, February 1967 it is shown that when the two distributions are normal multivariate of degree

$$n \text{:} {f}_{i} ( r ) = N ( {μ}_{i} , {\sum }_{i} ) and {f}_{j} ( r ) = N ( {μ}_{j} , {\sum }_{J} ) then$$

$${α}_{ij} = \frac{1}{8} {( {μ}_{i} - {μ}_{j} )}^{T} {\sum }_{ij}^{- 1} ( {μ}_{i} - {μ}_{j} ) + \frac{1}{2} ln \frac{det ( {\sum }_{ij} )}{\sqrt{det {\sum }_{i} det {\sum }_{j}}}$$

$$where {\sum }_{ij} = \frac{1}{2} ( {\sum }_{i} + {\sum }_{j} ) ,$$

the probability of misclassification Pₑ is bounded by

$$\frac{1}{8} {ρ}_{ij}^{2} \leq {P}_{e} \leq {ρ}_{ij}$$

which is equivalent to

$$\frac{1}{8} {( 1 - \frac{1}{2} {J}_{ij}^{2} )}^{2} \leq {P}_{e} \leq 1 - \frac{1}{2} {J}_{ij}^{2} .$$

The lower bound of Pₑ is reached when Jᵢⱼ=√2

The JM distance measure will express the quality of a chosen technique to distinguish between the clean and not clean surface cases. The complete spectra presented above were obtained using a dedicated spectrometer. For commonplace computer-vision techniques to be applied, we need to limit the number of frequencies analysed.

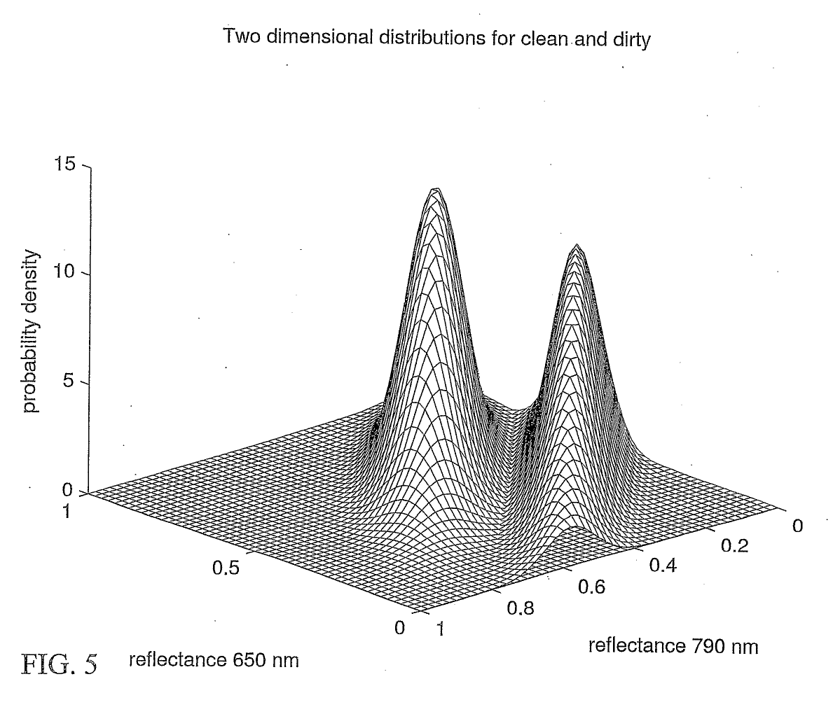

FIG. 4 illustrates the theoretic distribution of reflectance for the clean and not-clean cases if monochromatic light is used. The result is two normal distributions with a large overlap. If discrimination was based on a single wavelength, the area would correspond to misclassification given the surface was clean

$${P}_{e} ( {θ}_{d} \vert {π}_{c} ) = {\int }_{{r}_{sep}}^{1} p ( r \vert {π}_{ɛ} ) d r$$

where rₛₑₚ is shown as the dashed line in FIG. 5.1. Misclassification that the dirty surface was declared clean is

$${P}_{e} ( {θ}_{c} \vert {π}_{d} ) = {\int }_{0}^{{r}_{sep}} p ( r \vert {π}_{d} ) d r .$$

Using monochromatic or narrow-band light at a single wavelength was found to give a rather large overlap between distributions and hence a large probability of misclassification for all wavelengths when the surface is made of concrete.

If two monochromatic measurements are used, a two-dimensional distribution may be constructed as shown in FIG. 5. The two dimensions correspond to observing the reflectance of the surface at two different wavelength bands. The x-axis is reflectance obtained for band λ₁=790 nm and the y-axis is that obtained for band λ₂=650 nm. Whereas misclassification is large if either of the two wavelength bands is used individually, combining the two observations results in the two dimensional probability distribution functions shown with clear separation between the clean state and the contaminated state. The curves shown in FIG. 4 are the projections of the same distributions shown in FIG. 5. Thus, by regarding the two measurements as a two-dimensional presentation, it is indeed possible to discriminate using a separation in the x-y plane of reflectance as the boundary for classification.

### EXAMPLE

### Misclassification Bounds

This example details calculation of the misclassification bounds for the one and two-dimensional normal distributions shown in FIGS. 4 and 5.

The example demonstrates the benefit of treating the combined measurements as one vector measurement from a two-dimensional distribution that has correlation between its variables, in contrast to treating the two measurements as individual and uncorrelated, which they are not.

Let the two single wavelength observations be one-dimensional distributions A:N (μ_{A}, Σ_{A}) with mean and covariance specified for each of the wavelengths. The combined observation is C:N(μ_{c},Σ_{c}) where

$$\begin{matrix}A ( {λ}_{1} ) \text{:} & {μ}_{A} = {μ}_{A} ( 1 ) & {\sum }_{A} = {σ}_{A 1}^{2} \\ A ( {λ}_{2} ) \text{:} & {μ}_{A} = {μ}_{A} ( 2 ) & {\sum }_{A} = {σ}_{A 2}^{3} \\ C ( {λ}_{1} , {λ}_{2} ) \text{:} & {μ}_{C} = [ \begin{matrix}{μ}_{A} ( 1 ) \\ {μ}_{A} ( 2 )\end{matrix} ] & {\sum }_{C} = [ \begin{matrix}{σ}_{c 11}^{2} & {σ}_{c 12}^{2} \\ {σ}_{c 12}^{2} & {σ}_{c 22}^{2}\end{matrix} ]\end{matrix}$$

The covariance matrix for the distribution in the two dimensional case is calculated from the two single wavelength variances σ_{A1} and σ_{A2} and the correlation between the two measurements. The correlation is conveniently specified as an angle φ that shows maximum correlation with φ=π/4, none at φ=0 and φ=π2. Define a rotation matrix R by

$$R = [ \begin{matrix}cos φ & sin φ \\ - sin φ & cos φ\end{matrix} ]$$

The covariance for the two-dimensional case is then calculated from σ_{A1} and σ_{A2} as

$${Σ}_{C} = [ \begin{matrix}{σ}_{c 11}^{2} & {σ}_{c 12}^{2} \\ {σ}_{c 12}^{2} & {σ}_{c 22}^{2}\end{matrix} ] = {R}^{T} [ \begin{matrix}{σ}_{A 1}^{2} & 0 \\ 0 & {σ}_{A 2}^{2}\end{matrix} ] R$$

Parameters of the example shown in FIGS. 4 and 5 are listed in Tables 1, 2 and 3.

TABLE 1
Parameters for one-dimensional distributions at λ₁.

| parameter | A | B |
|---|---|---|
| λ | 650 | 650 |
| μ | 0.20 | 0.40 |
| Σ | 0.05² | 0.20² |

TABLE 2
Parameters for one-dimensional distributions at λ₂.

| parameter | A | B |
|---|---|---|
| λ | 790 | 790 |
| μ | 0.40 | 0.61 |
| Σ | 0.30² | 0.06² |

TABLE 3
Parameters for two-dimensional distributions.

| | | |
|---|---|---|
| parameter | A | B |

| | | | | | | |
|---|---|---|---|---|---|---|
| λ | {open oversize bracket} | 650790 | {close oversize bracket} | {open oversize bracket} | 650790 | {close oversize bracket} |

| | | |
|---|---|---|
| φ | π/4 | −π/4 |

| | | | | | | |
|---|---|---|---|---|---|---|
| μ | {open oversize bracket} | 0.200.40 | {close oversize bracket} | {open oversize bracket} | 0.400.61 | {close oversize bracket} |

| | | |
|---|---|---|
| Σ | $[ \begin{matrix}{0.2149}^{2} & - {0.2090}^{2} \\ - {0.2090}^{2} & {0.2149}^{2}\end{matrix} ]$ | $[ \begin{matrix}{0.1476}^{2} & - {0.1349}^{2} \\ - {0.1349}^{2} & {0.1476}^{2}\end{matrix} ]$ |

As the distributions A and B are normal, Bhattacharyyar's coefficient α is

$$α = \frac{1}{8} {( {μ}_{A} - {μ}_{B} )}^{T} {Σ}_{AB}^{- 1} ( {μ}_{A} - {μ}_{B} ) + \frac{1}{2} ln ( \frac{{det Σ}_{AB}}{\sqrt{{det Σ}_{A} {det Σ}_{B}}} )$$

$$where$$

$${Σ}_{AB} = \frac{1}{2} ( {Σ}_{A} + {Σ}_{B} )$$

The probability Pₑ of misclassification has the bounds

$$\frac{1}{8} exp ( - 2 α ) \leq {P}_{e} \leq exp ( - α ) .$$

Table 4 lists the results for the three cases. It is evident that combining the two measurements dramatically improves the misclassification probability using the parameters of this example. It is noted that the correlation was set to its maximum with the parameters chosen here.

TABLE 4
Calculation of α and bounds for Pₑ for the three cases.

| case | α | inf (Pₑ) | sup (Pₑ) |
|---|---|---|---|
| JM(A, B) for λ₁ | 0.612 | 0.037 | 0.54 |
| JM(A, B) for λ₂ | 0.596 | 0.038 | 0.55 |
| $JM ( A , B ) for [ \begin{matrix}{λ}_{1} \\ {λ}_{2}\end{matrix} ]$ | 3.499 | 0.0001 | 0.030 |

With this approach being promising, the formal approach in connection with the invention was to design a sensor system starting with choosing two wavelengths, or more, that together gave a desired low level of misclassification. Second, a method was needed to find the discriminator function to be used.

Choice of Wavelength Bands

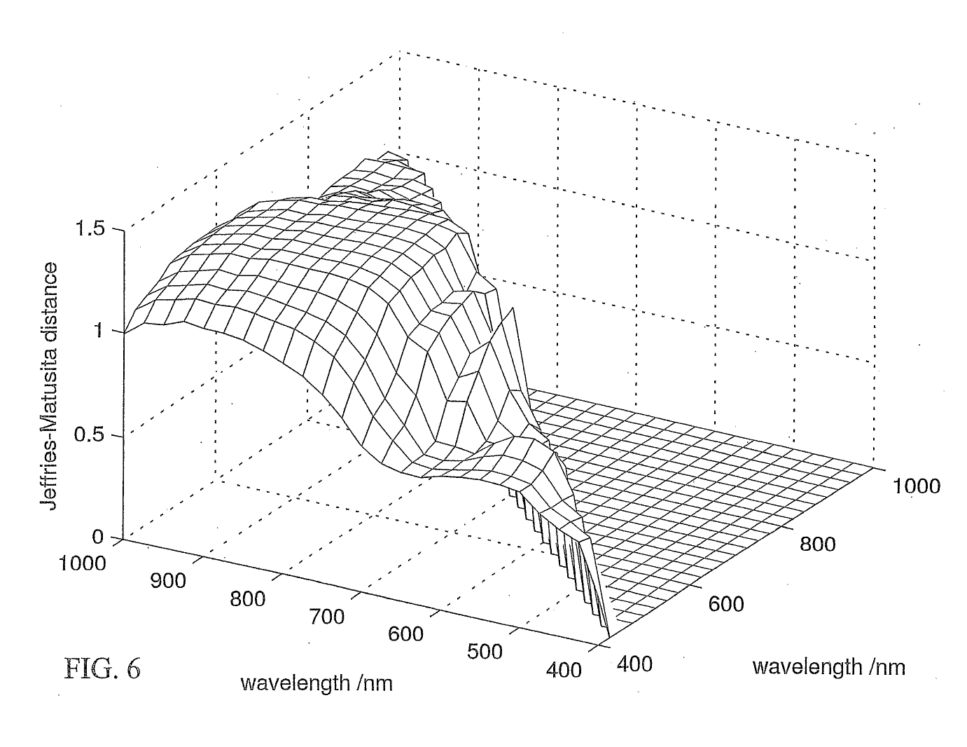

In connection with the invention, it was first investigated which pair of two frequency bands would be optimal based on minimising the probability of misclassification. This is equivalent to maximising the JM distance. FIG. 6 shows the JM distance measure using actual data for concrete.

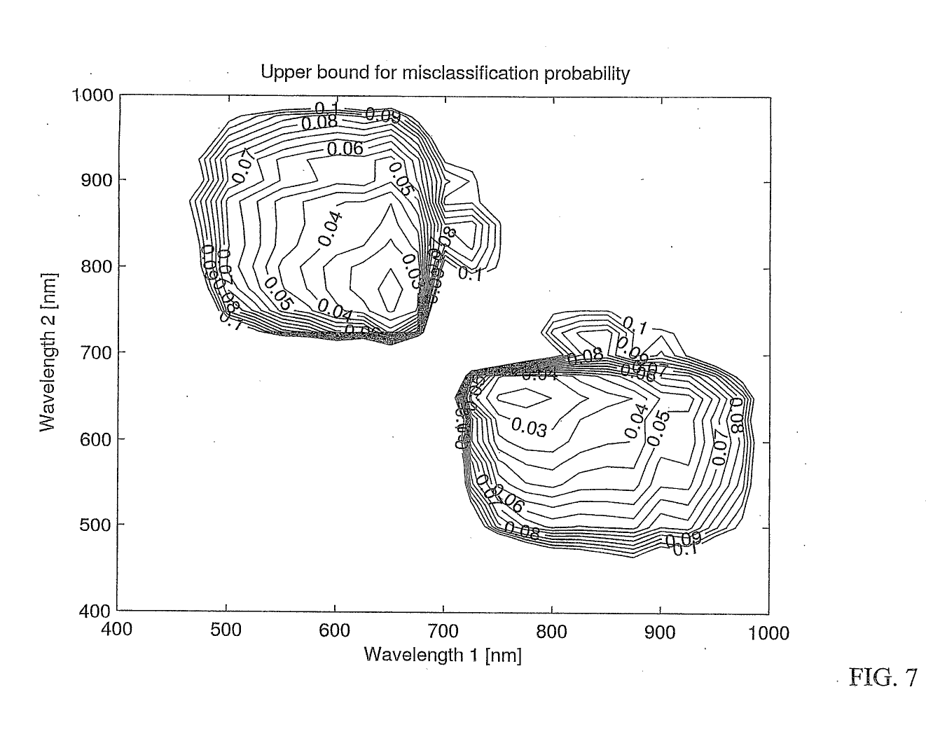

FIG. 7 shows a contour plot for the misclassification bound in the range 0-10%. Using two narrow bands around wavelengths 780 nm (infrared) and 650 nm (orange) we obtain a misclassification probability below 2%, which is certainly acceptable for the application.

The results presented thus far, in FIG. 6, showed an obtainable upper bound for misclassification to be acceptable when two specific wavelengths were used for illumination on concrete, another pair of wavelengths were needed for a steel surface.

The question whether two-wavelength discrimination would be possible for all relevant surface materials in a pig house was investigated using samples of a solid concrete and a slatted floor. Both samples had a history of 15 years of use. The surface colours of the aged materials were easily distinguished from those of samples from new build floors, the aged materials being clearly patinated into the brown range.

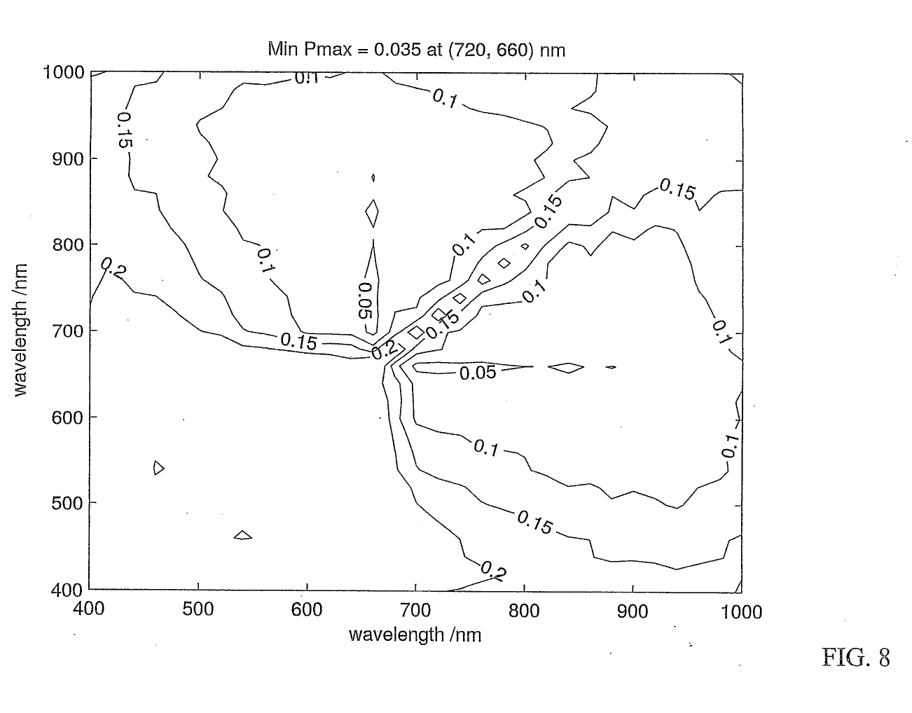

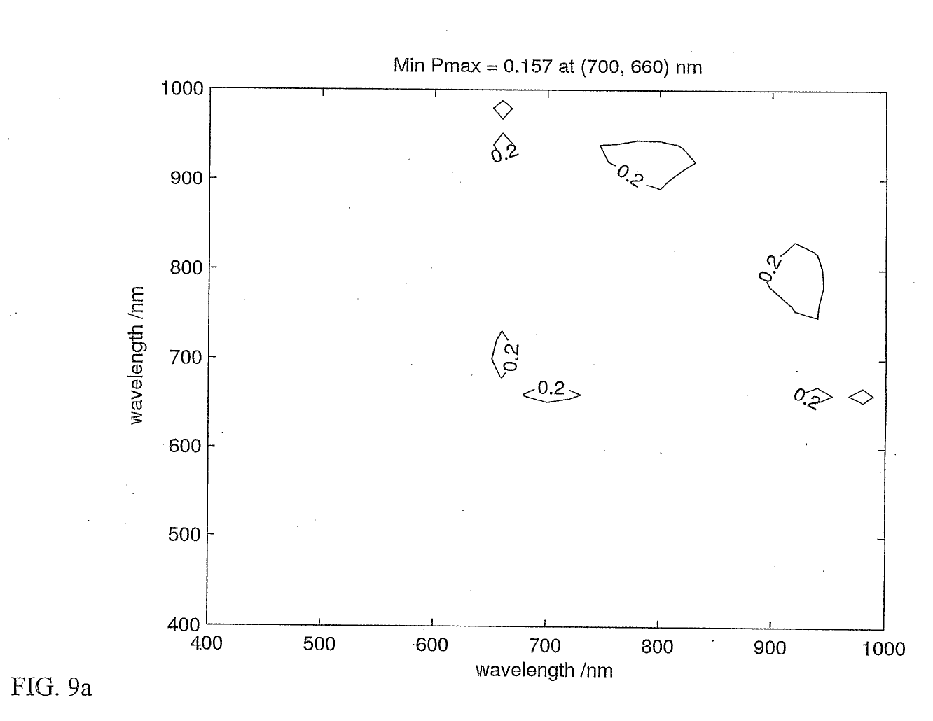

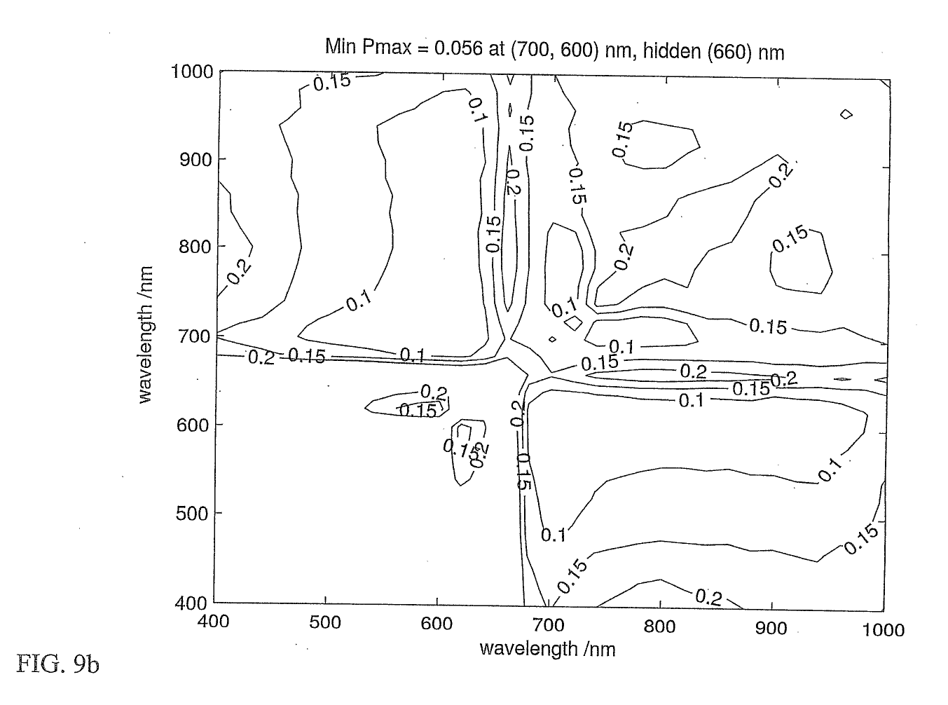

The results of running the JM tests on the aged materials are shown in FIG. 8 for an aged solid concrete floor and FIG. 9a for an aged slatted concrete floor. A two-wavelength discrimination was not suited with the slatted floor down to an acceptable level of misclassification. The next step natural step was to determine, whether use of additional wavelengths would improve the misclassification probability.

Obtaining a sufficiently low value of the upper bound for misclassification in the JM setting is an optimisation exercise. Whilst misclassification probability is expected to decrease by the number of frequencies employed in the analysis, up to a certain number of such spectral components, there is no need to use more wavelengths than necessary to obtain the desired limit. There is clearly an impact on cost, complexity and time to analyse when more wavelengths are employed. However, in the presented case, it was useful to include another wavelength. The result of a three-wavelength optimisation exercise is shown in FIG. 9b for an aged slatted concrete floor. As compared to FIG. 9a, a clear improvement was reached. It was concluded that a set of three distinct wavelengths suffice to obtain an acceptable 5.6% misclassification level for all surface samples that were available for this study.

Sensor Design

The sensor that was used in tests for the invention is pixel based: each pixel is classified either as “clean” or “dirty”. The classification procedure is Bayesian discriminant analysis, which assigns pixel measurements to classes from which they are most likely to have been produced. The method relies on adequate knowledge of the statistics of the possible classifications, in this work the measurements presented above form the basis of the discriminator.

The spectrographic characteristics of pig house surfaces provide much more data than is expected from the camera based sensor. The camera sensor provides a small number of channels, each described by the pair of filter/illumination characteristics for the respective channel. In the design presented here, each channel is restricted to a narrow band of frequencies, produced, for example, by a number of powerful light emitting diodes. The sensor collects images corresponding to each channel in turn, by sequencing through the light sources for each channel. By synchronising the light sources to the camera's frame rate, a set of images corresponding to a single two dimensional measurement can be acquired in a relatively short time.

From the spectra presented above, a number of wavelengths were selected such that classification into clean and dirty classes for pig house surface materials was possible. While some materials may be amenable to classification based on a single light colour—consider, for example, the green plastic in FIG. 2d at around 490 nm or 620 nm—concrete, the most important material, is clearly not. However, as illustrated previously, multi-dimensional analysis can reveal structure that is sufficient to discriminate classes.

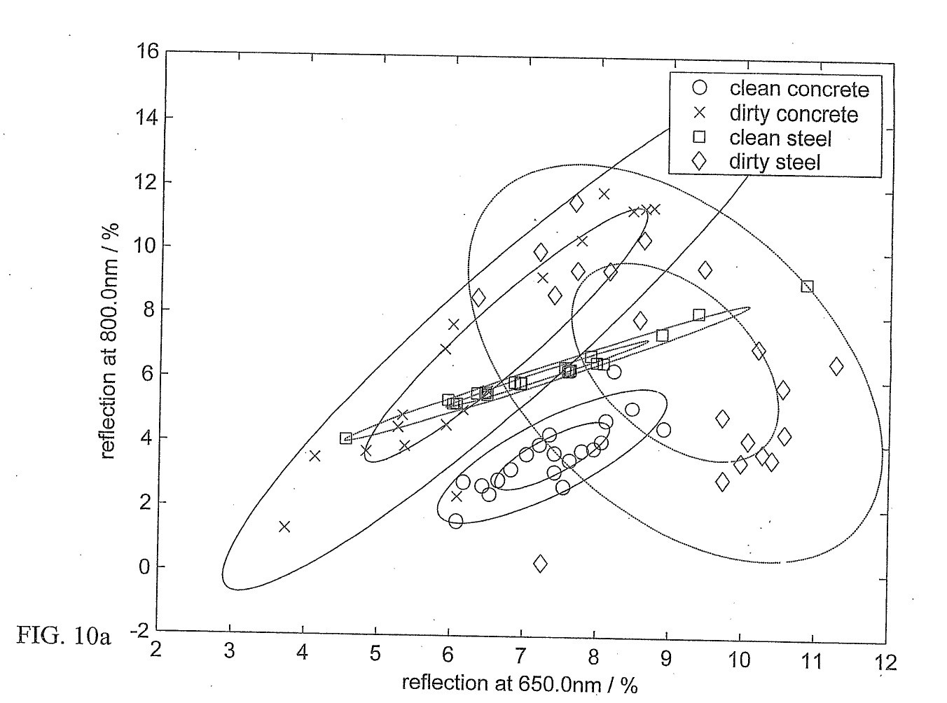

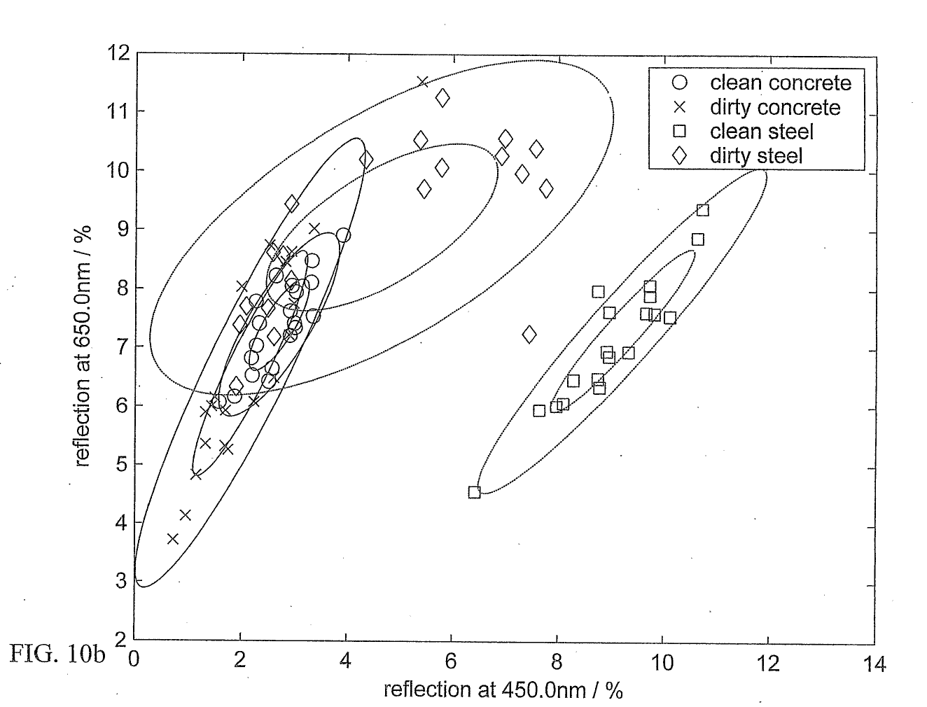

Selecting the wavelengths 800 nm and 650 nm, for example, the surface characteristics can be illustrated in the scatter plot shown in FIG. 10a. Four populations are shown, corresponding to wet concrete and steel, in both clean and dirty conditions. As can be seen, with these wavelengths, clean and dirty concrete are well separated, whereas clean and dirty steel share a significant overlap. Selecting 650 nm and 450 nm on the other hand, as shown in FIG. 10b, separates clean from dirty steel, but fails for concrete. Using all three wavelengths, a discriminator can be constructed to handle both material types.

From the training data and the choice of wavelengths determined as just described, a number of populations πᵢ are modelled as normally distributed, multidimensional random variables.

πᵢ [symbol] N(λᵢ,Σᵢ)

Using the experimental data, xᵢⱼ, for each class i, estimates of the mean vectors and variance-covariance matrices for each population can be derived.

$${\hat{μ}}_{i} = \frac{1}{n} {\sum }_{j} {x}_{ij}$$

$${\hat{Σ}}_{i} = \frac{1}{n - 1} {\sum }_{j} ( {x}_{ij} - {\hat{μ}}_{i} ) {( {x}_{ij} - {\hat{μ}}_{i} )}^{′}$$

A Bayesian classifier assigns new measurements to the population from which the measurement is most likely to be associated. Bayes' rule states that the probability that a measurement x is associated with the class πᵢ is given by

$$P ( {π}_{i} \vert x ) = \frac{P ( {π}_{i} ) P ( x \vert {π}_{i} )}{P ( x )} .$$

A Bayesian classifier assigns a measurement to the class for which probability calculated in the equation above is highest. The term P(x|πᵢ) is simply the probability distribution function for class i, which can be written fᵢ(x), and P(πᵢ) is the prior probability of class i, which can written pᵢ. The denominator P(x) is independent of the class, and is therefore irrelevant with respect to maximising the equation across classes. Thus, a Bayesian classifier chooses the class maximising

Sᵢ=fᵢ(x)pᵢ

where Sᵢ is referred to as a discriminant value or score. The term pᵢ is the a priori probability of a measurement corresponding to the population πᵢ, and reflects knowledge of the environment prior to the measurement being taken.

The probability distribution for the classes may be a normal distribution, but the method according to the invention is not limited thereto in any way.

If the probability distribution can be described by a multi-dimensional normal distribution, the probability density of class i is given by

$${f}_{i} ( x ) = \frac{1}{{\sqrt{2 π}}^{n}} \frac{1}{\sqrt{det {\hat{Σ}}_{i}}} {e}^{- \frac{1}{2} {( x - {\hat{μ}}_{i} )}^{′} {\hat{Σ}}_{i}^{- 1} ( x - {\hat{μ}}_{i} )} .$$

Substituting this into the upper equation for Sᵢ yields the discriminant value for the normally distributed case. In practise, the same decision rule is achieved by applying a monotonic transformation of Sᵢ, so that

$${S}_{i} ( x ) = log \frac{ {p}_{i}}{\sqrt{det {\hat{Σ}}_{i}}} - \frac{1}{2} {( x - {\hat{μ}}_{i} )}^{′} {\hat{Σ}}_{i}^{- 1} ( x - {\hat{μ}}_{i} )$$

is minimised instead. Since this function is quadratic in x, it is known as a quadratic discriminant function.

As just mentioned, the Bayesian classification method is not restricted to normally distributed variables, and the method may be extended by adding a new class corresponding to “unknown”, or “not likely to belong to any of the known classes”.

Clearly, a distribution for “unknown” is not easily available, nor is it clear how it should be measured. Instead, it is assumed that an unknown, or default, class, is equally likely to have any measurement value. In the case of our measurement images, this corresponds to a pixel illumination measurements evenly distributed between black (zero) and white (one).

For this class (0), we have

f₀(x)=αand S₀=p₀+log(α)

where α is a scale factor with the property that f₀(x) integrated over the image is 1 and p₀ is the a priori probability of a measurement pixel belonging to the default class. This is a parameter that can be adjusted according to the likelihood of unclassified materials or surfaces being present in the captured images.

The JM distance measure has all of the features needed for this application, including: ability to handle signals with dissimilar distributions; analytic upper and lower bounds exist for the misclassification probability; this distance measure is symmetric in its variables. However, other measures of distance or divergence between stochastic variables could be used as well.

In connection with the invention, a computer program has been developed to perform the determination, automatically, whether a region is contaminated or not. This has been used as part of the integration of the invention in a cleaning robot.

A data flow diagram for a program illustrates the main flows of data, under normal program operation, between program inputs, outputs, processes and data stores. Two common notations exist for these diagrams, Gane and Sarson's and Yourdon and Coad's. The two notations are rather similar, using slightly different symbols for the four elements:

1. Processes

2. Datastores

3. Dataflow

4. External entities

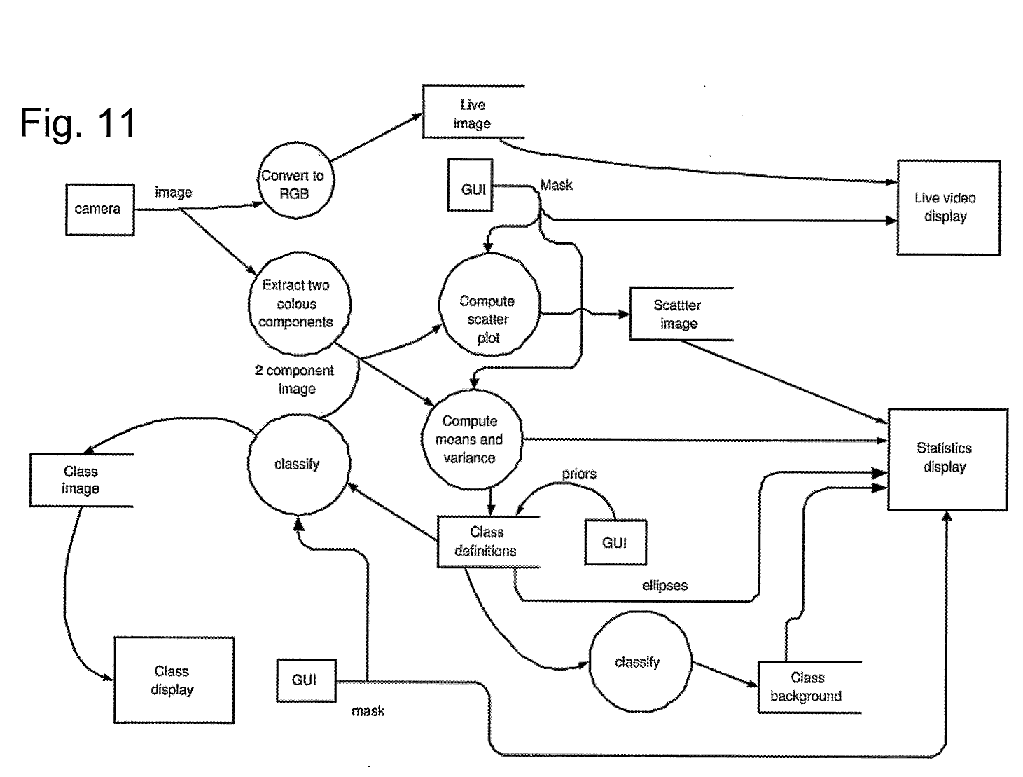

A data flow diagram for this program, mostly following Yourdon and Coad, is shown in FIG. 11. As much as possible, flow runs from top left to bottom right. Inputs and outputs are shown with rectangular boxes—the main input to this program is the video camera which is shown top left. Three outputs are shown—the three image displays showing live video, statistics and classified pixels. Within the diagram, further input is obtained from the user (GUI—graphical user interface). Processes are shown with circles. A process represents a computation on, or transformation of, data. Data stores are shown as open rectangles and represent program state. Data flows are drawn with directed arcs.

Two types of data store are used, one for storing class definitions across program runs, and one for storing generated images during program operation. Whether or not these intermediate images should be represented as data stores or simply as data flows is perhaps a matter of taste—data flow diagrams are not an exact science. The reason for choosing data stores for these is to reflect the fact that this is how computer display systems usually work—complex images are stored so that displays can be asynchronously updated, for example, when a window is moved and a previously hidden area must be redrawn.

Several paths through the data flow chart can be readily identified. Starting at the top left, for example, and continuing to the right, the flow camera→convert to RGB→live image→live video display can be traced. Here, camera and live video display are external devices, convert to RGB a process and live image a data store. This path is responsible for updating the live video display window with new data from the camera.

Three paths start with GUI at top center, with the dataflow labelled mask. This is a circular area the user can manipulate drawn over the live video, to select a subset of the live pixels. One path leads directly to live video display, where the mask itself is drawn as a dotted outline. The two remaining paths lead ultimately to the statistics display. One path provides input to the scatter plot generator, the other to the means and variance computation—in both cases providing information about which pixels should be considered. The main algorithm of the program, describing the processing steps following the capture of a new image through to display update can be described as follows.

Given:

1. A list of classes, cₖ=(μₖ, Σₖ, pₖ), with mean vectors, variance-covariance matrices and prior probability, respectively, describing the various surface materials in clean and dirty conditions.

Repeat:

1. Read a new image from camera:

$$X = [ \begin{matrix}{x}_{11} & & \\ & ⋰ & \\ & & {x}_{hw}\end{matrix} ] .$$

2. Calculate, for each pixel xᵢⱼ and class c_{q},

$${S}_{ijq} = \{ \begin{matrix}\frac{{p}_{q}}{\sqrt{det {Σ}_{q}}} {e}^{- \frac{1}{2} {( {x}_{ij} - {μ}_{q} )}^{′} {Σ}_{q}^{- 1} ( {x}_{ij} - {μ}_{q} )} & {c}_{q} ∈ \{ clean , dirty \} \\ {p}_{q} {α}_{q} & {c}_{q} ∈ \{ unknown \} .\end{matrix}$$

Update pixel classifications as

$$Y = [ \begin{matrix}{y}_{11} & & \\ & ⋰ & \\ & & {y}_{hw}\end{matrix} ]$$

choosing yᵢⱼ=cₖ such that

$${S}_{ijk} = {max}_{q} {S}_{ijq} .$$

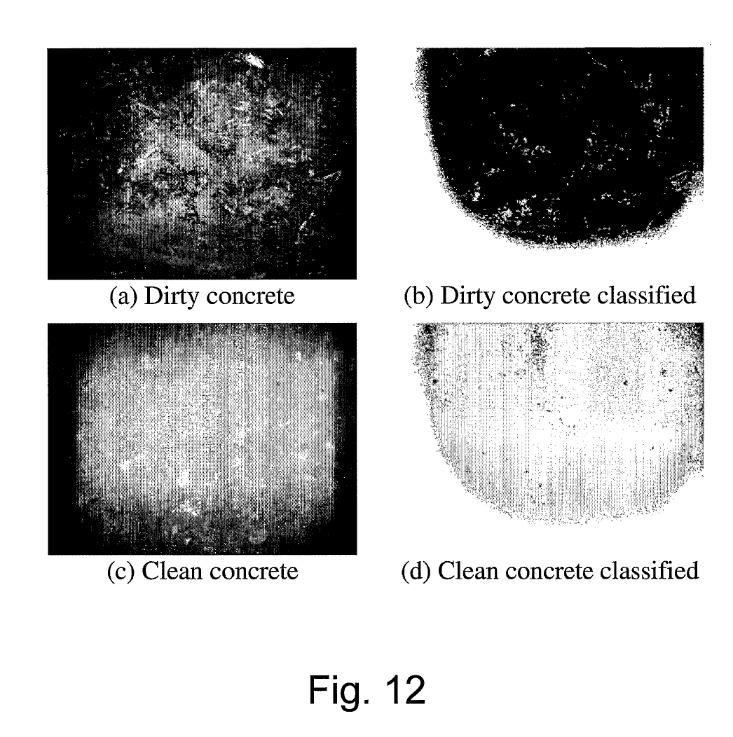

FIG. 12 shows results of the algorithm used on images from a pig pen.

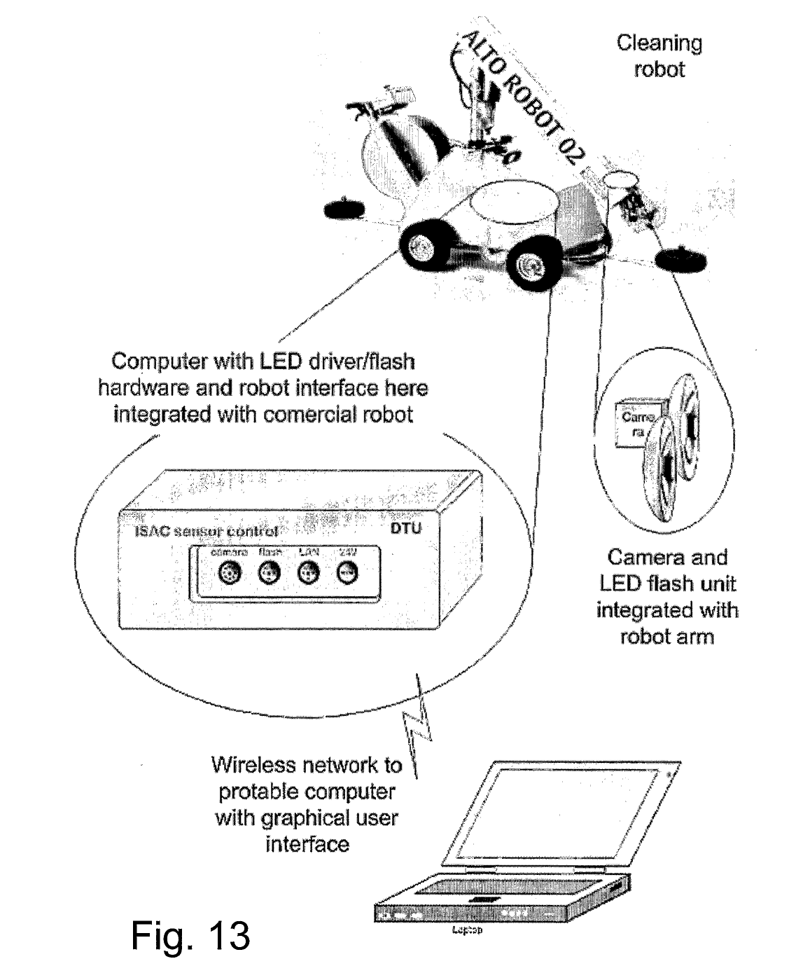

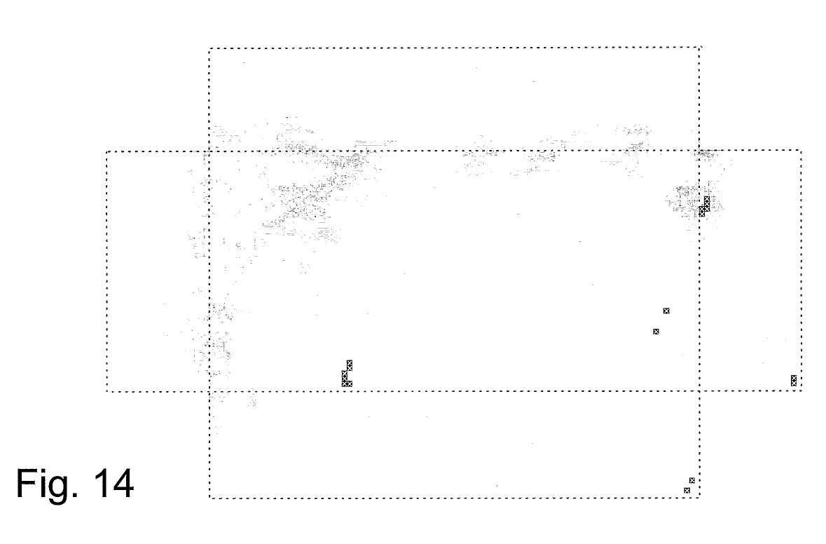

FIG. 13 illustrates how the components of the sensor system are mounted on a commercial cleaning robot. The camera and lighting are mounted on the robot arm in a dedicated enclosure protecting these from first and humidity. Signals from the camera are fed to the central processing unit (computer) that comprises the classification software. Results of the classification are used to form a cleanness map, shown in FIG. 14, which is subsequently used to guide the robot-based cleaning. The computer has the ability to communicate with an operator station (graphical user interface) via a wireless connection. The connection between the computer and camera could be wired or be wireless. Signals from the camera are received by a frame grabber in the computer but other configurations could be used as well. Analysis of the images captured on the CCD chip could, for example, be treated locally within the camera before they are sent to the classifier software.

The cleanness map as illustrated in FIG. 14 is depicting the degree of cleanness of the four walls (side parts of image) and the floor (central part of image) in a pig pen. The degree of contamination is indicated by the level of grey where black means 100% of 2×2 mm pixels in a 10×10 cm area were classified as dirty.

The vision system produces a map of cleanness for surfaces inspected. The map is represented in a database with data indicative for the location and the corresponding cleanness. FIG. 14 shows a grey-scale visual impression of the results. Present and antecedent data are compared for all area elements. This comparison may indicate that special treatment is required, which might include manual inspection. Such segments are indicated in the map and shown as white x'es on a black background in FIG. 14.

This map is subsequently used to determine cleaning patterns and associated motion of robot joints and the cleaning device to perform the cleaning. In one implementation, the cleaning device is a high-pressure nozzle spraying water with possible additives to remove dirt.

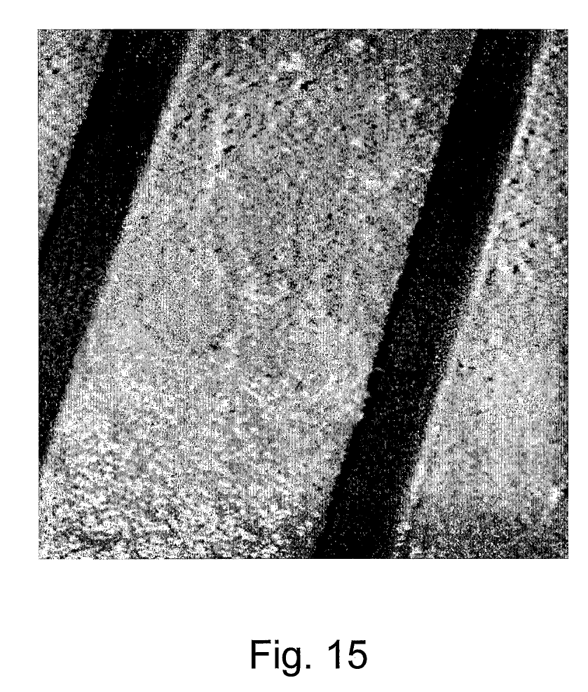

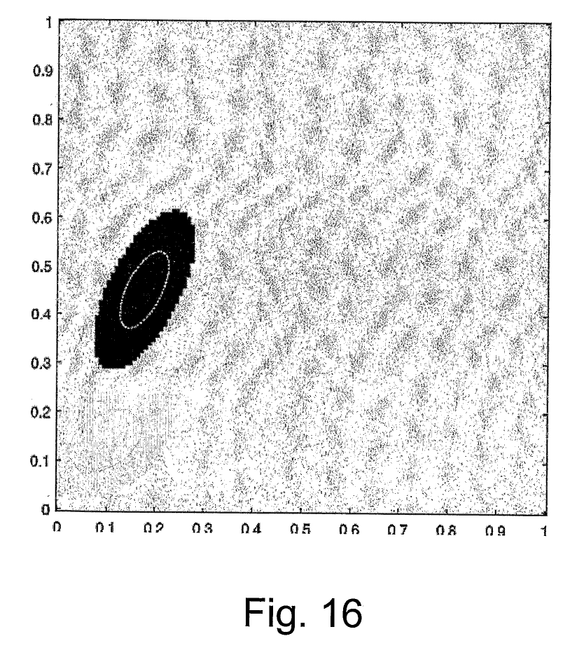

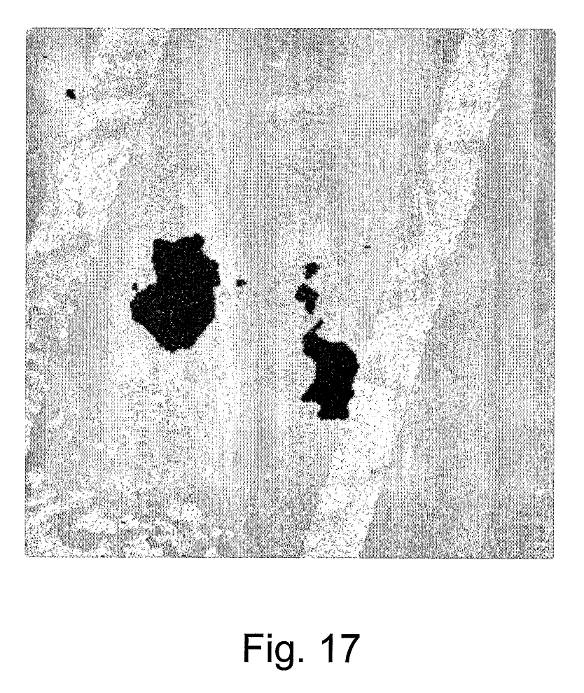

FIG. 15 is an image of a wet slatted floor with lumps of dirt that are hardly visible. The floor on the image has two straight gaps across the image. FIG. 16 shows the corresponding classification map; the horizontal axis shows reflection at 660 nm and the vertical axis shows reflection at 890 nm. In this classification map, two areas are pronounced, namely a dark area associated with dirt and a dark gray area associated with the clean surface. FIG. 17 shows the cleanness map corresponding to the image FIG. 15 illustrating that the classification is able to localize the areas with remains of dirt, show where the surface is clean and mark the gaps as areas that are classified as not belonging to any of the two sets, clean or dirty. This series of figures clearly demonstrates that not only dirt can be discriminated against clean surfaces, but other objects may as well clearly be discriminated against the dirt and also against the clean surface.

As a conclusion, areas that exhibit local parts with scratches, surface damages or are partly made of materials with different composition can be discriminated using appropriate variation in parameters of the classifier. Parameters of the classifier can generally be made specific for inspection of different locations of the surface.

Further improvements of the invention can be achieved by the following. Automated and user assisted learning can be used to aid the classification of difficult areas such that the classifier parameters are changed according to local conditions. A certain location is associated with certain classifier parameters.

In an implementation where the sensor is mounted on a robot, robot coordinates could be used to determine which part of a surface is being inspected and hence determine which parameter set should be used for classification of a particular part of an image.

In an implementation where vision based localization is used, picture coordinates are transformed to represent coordinates on the surface, and these are in turn used to select the appropriate classifier parameters.

Areas that appear uncertain in one picture, for example due to reflections, are interpreted by the sensor software and the position and orientation of the sensor is changed to take pictures of the same area from other angles. Sets of pictures may be used to form a cleanness map. Overlapping pictures are classified jointly such that areas classified with high probability supersede results with uncertain classification. The joint classification between overlapping pictures is in general a nonlinear function of location and classification probability obtained in the areas that overlap.

The essential parameters of the classifier are those that describe the shape of the areas in the vector space spanned by reflection at the different wavelengths that we wish to characterize as clean, respectively dirty.

1. A method for optically determining whether a region of a surface is clean or contaminated, the method comprising the steps of:
selecting a first and a second, different narrow band of wavelengths for illuminating the region,
selecting a first class with two-dimensional values [X1, Y1] that corresponds to a definition as clean for the region and a disjunct second class with two-dimensional values [X2, Y2] that corresponds to a definition as contaminated for the region, where X1 and X2 are values for the reflectance from the region at the first band, and Y1 and Y2 are values for the reflectance from the region at the second band,
illuminating the region with light having the first narrow band of wavelengths and illuminating the region with light having the second narrow band of wavelengths,
measuring the reflected light from the region at the first and the second band to determine the respective reflectance values R1 and R2, and
assigning the two-dimensional value [R1, R2] to the first class, if there exist a value [X1, Y1] that is equal to [R1, R2] and assign the two-dimensional value [R1, R2] to the second class, if there exist a value [X2, Y2] that is equal to [R1, R2].

2-17. (canceled)

18. The method according to claim 1 wherein the illumination of the region is with light containing the first narrow band of wavelengths and the second narrow band of wavelengths and additional light with wavelengths outside the first and the second narrow band, and wherein the measuring of the reflected light includes filtering of the light with a wavelength filter having a selection of wavelengths only in the first narrow band of wavelengths and the second narrow band of wavelengths.

19. The method of claim 18, wherein the illumination of the region is with broadband light.

20. The method of claim 18, wherein the illumination of the region is with light sources emitting light containing only narrow bands of wavelengths.

21. The method of claim 20, wherein the illumination of the region is with light sources emitting light containing only the first narrow band of wavelengths and the second narrow band of wavelengths.

22. The method of claim 1, further comprising image acquisition with an optoelectronic system of the surface that contains the region and subsequent image processing, where the image of the surface is acquired in sections, where the image section is divided into a multiplicity of pixels forming an image matrix and each pixel is assigned a signal value representative for the reflected light from the corresponding region.

23. The method of claim 1, wherein the selection of the two-dimensional values for the first and the second class involves determining a probability density X for the reflectance from the region at the first band and a probability density Y for the reflectance from the region at the second band, and in a two-dimensional representation with the reflectance values of X and Y as entrances, respectively, selecting a border between two groups of entrances, where one group is representative for a clean region and the other group is representative for a contaminated region.

24. The method of claim 1, wherein the selection of the first and the second band of wavelengths involves calculation of the Jeffreys-Matusita distance for reflectance probabilities for a range of first wavelength bands and a range of second wavelength bands and selecting a combination of the first and the second wavelength bands for which the Jeffreys-Matusita distance is above 0.8.

25. The method of claim 24, further comprising calculating a misclassification error bound for reflectance probabilities for a range of first wavelength bands and a range of second wavelength bands and selecting a combination of the first and the second wavelength bands for which the misclassification error bound is below a value of one minus half the Jeffreys-Matusita distance squared, 1½·JM².

26. The method of claim 1, further comprising: selecting a third narrow wavelength band, selecting a first class with three-dimensional values [X1, Y1, Z1], which corresponds to a clean region and a second class with three-dimensional values [X2, Y2, Z2], which corresponds to a contaminated region, where Z1 and Z2 are values for the reflectance from the region at the third band,
illuminating the region in addition with light having the third band,
measuring in addition the reflected light from the region at the third band to determine the respective reflectance R3,
assign a three-dimensional value [R1, R2, R3] to the first class, if there exist a value [X1, Y1, Z1] that equals [R1, R2, R3], and assign the three dimensional value [R1, R2, R3] to the second class, if there exist a value [X2, Y2, Z2] that equals [R1, R2, R3].

27. The method of claim 1, wherein the first band is about 800 ran and the second band is about 650 nm when determining the cleanliness of concrete, or the first band is about 650 nm and the second band about 450 nm when determining the cleanliness of steel.

28. The method of claim 1, wherein the method further comprises inspecting a surface for the cleaning process and producing a cleanness map for the surfaces with data indicative of the degree of cleanness in dependence of the location.

29. The method of claim 28, wherein the method further comprises evaluating the degree of cleanness in relation to predetermined criteria and indicating on the cleanness map the location, where the found degree of cleanness does not correspond to the predetermined criteria.

30. The method of claim 1, wherein the method further comprises cleaning an animal houses.

31. An apparatus for performing the method of claim 1 comprising an illuminator for illumination with the first wavelength and the second wavelength, a digital video camera electronically coupled to a computer for measuring the reflected light with a spatial resolution, the camera being arranged to detect the reflected light under conditions minimising the direct reflection from the surface of the region.

32. A cleaning robot for performing the method of claim 1, wherein the cleaning robot comprises a vehicle onto which at least one robot arm is mounted, and wherein an illuminator for illuminating the region with light having the first narrow band of wavelengths and illuminating the region with light having the second narrow band of wavelengths is mounted on a robot arm and wherein a camera for measuring the reflected light from the region at the first and the second band is mounted on a robot arm.

33. A cleaning robot comprising an apparatus of claim 31, wherein the cleaning robot comprises a vehicle onto which at least one robot arm is mounted, and wherein the illuminator for illuminating the region with light having the first narrow band of wavelengths and illuminating the region with light having the second narrow band of wavelengths is mounted on a robot arm and wherein the camera for measuring the reflected light from the region at the first and the second band is mounted on a robot arm.
